(19) United States
(12) Patent Application Publication
(10) Pub. No.: US 2003/0049353 A1
(43) Pub. Date: Mar. 13, 2003

(54) Raw dough or baked product that can be prepared in an oven or microwave oven in the form of a pizza slice with an enclosed filling that is covered with a crust

(75) Inventors: Stacey M. Lauen, Edina, MN (US); David C. Rettey, Tracy, MN (US)

Correspondence Address: MERCHANT & GOULD PC, P.O. BOX 2903, MINNEAPOLIS, MN, 55402-0903, US

(73) Assignee: Schwan's Sales Enterprises, Inc.

(21) Appl. No.: 09/952,716

(22) Filed: Sep. 12, 2001

(51) Int. Cl. A23G 3/00

(52) U.S. Cl. 426/94

(57) ABSTRACT

An individual sized portion of a pizza food can comprise a roughly triangular portion having a crust that substantially encloses the pizza filling held within the crust. The crust is easily cooked, handled by a consumer and prevents contact between consumer and the filling during preparation and consumption. The food item is manufactured by forming a filling layer between two crust layers, sealing the perimeter of the crust into a roughly triangular portion and baking the portion at a manufacturing facility prior to shipment to a consumer. The dough and filling are formulated for convenient microwave cooking. The item can include a crispy crust, a non-toughening dough formula, a non-boil filling, an entirely sealed product envelope, a browning agent and a pizza condiment seasoning on the crust of the item.

### FIELD OF THE INVENTION

The invention relates to a pizza food manufactured in a convenient, single sized serving portion that is easy to bake or reheat and use, convenient for consumption and adapted for microwave, conventional oven or other preparation.

### BACKGROUND OF THE INVENTION

Production, manufacture and use in a home or institutional environment of a pizza slice has been an attractive option for many years. Microwave or conventional reheating of cooked frozen pizzas saves time, travel and expense and can be used at the convenience of the consumer. Frozen, single crust whole pizzas are typically prepared by the consumer in a conventional oven, microwave or a toaster oven. One form of consumer configured pizza food in which a single portion dough wrapper is placed around a filling of sauce and cheese often called a pizza pouch is known. These products are typically roughly cylindrical or roughly rectangular and are typically formed in “snack size” portions. Stuffed pizzas are also known are all served by slicing a stuffed pizza into individual serving size portions with unsealed sides. Calzone food items are also known but are typically large spherical difficult handle food items. Related products are known in dessert-like portions such as pop-tarts or toaster strudel products. These products tend to be roughly rectangular in shape and typically comprise a light, sweet dough with dessert-type filling such as fruits, custards, etc. Such conventional convenience foods have been well known for many years. Such products have obtained some success of the commercial marketplace but cannot provided a convenient, non-messy food. Further many microwavable products do not obtain an ultimate crispy nature in the cooked food.

A strong need has developed in the art for a pizza food adapted for reheating in conventional, thermal or convection ovens, microwaves or toaster ovens having a ready to eat configuration, a hearty meal size portion and an easily handled non-messy, non-drip format. Such a food will be easily handled, easily reheated and attractive to typical consumers of such foods including school age children, military personnel, or individuals any other feeding locus.

### SUMMARY OF THE INVENTION

The invention is directed to an individual serving size portion of a pizza food configured for manual handling, reheating and consumption. The food comprises in a baked or unbaked form, a substantially triangular base or bottom dough layer. The triangular layer can have two sides of substantially equal length with a third curved or straight edge of a different dimension. The triangular base or bottom layer is typically shaped like a conventional pizza slice comprising typically ¼ to 1/10 sector of a circular pizza. The triangular base dough layer can be combined with a sealing dough layer having a shape conforming to the edge and side dimensions of the base layer with a pizza filling held therebetween. The base layer and the sealing layer forming a mechanically stable joint along the edges of the base dough layer for the purpose of sealing dough layer around the filling. The seal maintains the filling substantially within the sealed food item during manufacture, storage, distribution, sale, reheating and ultimate consumption. While the pizza food of the invention is configured to maintain an enclosure for the filling, small vent openings can be made in the crust layer to permit steam escape during manufacture and reheating. The edge of the slice can comprise a straight edge or a curved edge. The pizza slice of the invention is packaged in a unique packaging material. The pizza slice or two or more slices are associated with a support and are placed in a film wrapping, with optional labeling. The support for the slice extends past the edge dimension of the pizza to protect the periphery of the pizza from damage. The edges and each apex of the triangle are protected from damage during manufacture, distribution and use by the package configuration. The support can comprise a susceptor surface or structure that can be used to both package the food and reheat the food during preparation and consumption. The susceptor can be formed in an envelope form that can enclose and supportably substantially contain the slice. A preferred triangular from of the susceptor envelope can be used as a convenient container for the hot food during consumption. The consumer can use the envelope to contain the food and permit it to cool until ready to eat. The slice is kept out of contact with the user and contamination from the environment while in the container envelope but is convenient to the consumer when needed. For the purpose of this patent application, the term “slice portion” is intended to connote a roughly isosceles triangular shape portion. The isosceles triangle having two sides of roughly equal dimensions with a base edge in a typically smaller dimension that can be straight edge or curved.

### BRIEF DESCRIPTION OF THE DRAWINGS

FIGS. 1-3 are photographic representations of the pizza food of the invention after microwave reheating. Apparent from the Figures are the triangular shaped slice portion of the food of the invention. Also apparent from these Figures are the sealed edge, the vent for cooking vapor and the cheese or herbal topping.

FIGS. 4-7 are graphical representations of the pizza slice of the invention showing the top sealed edge and two embodiments of the sealed side (FIGS. 6 and 7). FIG. 7 shows an embodiment of the invention in which the edge comprises a sealed cylindrical and could contain a cheese portion.

FIG. 8 is a representation of an imprint pattern of a tool used to seal and cut individual serving size portions of the pizza food.

FIG. 9 and representation an unfolded susceptor container used for packaging and reheating of the pizza food before consumption.

FIG. 10 is photographic representation of the susceptor of FIG. 9 in a folded form containing one pizza slice serving size portion.

FIG. 11 is a photographic representation of the packaged pizza food of the invention using the susceptor/support and film.

### DETAILED DESCRIPTION OF THE INVENTION

The pizza food of the invention is a typically triangular shaped pizza slice. The pizza slice comprises a pizza filling wholly contained within a triangular shaped outer crust. The outer crust is typically made from a base crust and a sealing crust sealed around the perimeter. The food can contain a topping made by combining cheese and an herbal ingredient. The pizza filling typically comprises a pizza sauce combined with other meats, cheeses, herbs and other ingredients. An important characteristic of the sauce is that the sauce is a stabilized filling or sauce at reheating temperatures. In other words, the two pizza sauces are typically stable at temperatures greater or about 250° F. Such a non-boiling effect is typically obtained by a combination of starches, gums, solid ingredients, components, and salts content.

Apart from the reheat stability of the fillings, the major goals to be achieved are taste and texture, reduced water content, tomato sauce or paste content and the blend of cheese, spices, and optional meat ingredients completing the filling. Typical tomato concentrates, pastes or sauces are used as a base component combined with other solid ingredients such as cheese, meats, prepared meats and herbs. Ingredients that can complete the pizza sauce components include thickeners such as starches, non-fat dry milk, oil, chopped vegetables and other conventional ingredients. Meat components of the filling include conventional pizza ingredients including sausage, Italian sausage, pepperoni, ham, ground beef, chicken portions and other conventional meat ingredients formed in convenient product sizes for use in filling recipes. The cheese component for use in the pizza portions of the invention includes mozzarella cheeses, jack cheeses, American cheese, Swiss cheese and other common cheese products.

The pizza of the invention can be made in a variety of culinary styles including an Italian style, a Vegetarian style, a Southwest style, a Mexican style, a Tex-Mex style, a Greek style, a Hawaiian style, and other common food styles. An Italian style food typically comprises tomato sauce, pepperoni or Italian sausage, mozzarella cheese and Italian seasonings including oregano, garlic, etc. A Vegetarian style food typically comprises tomatoes, onions, mushrooms, green or black olives and seasonings. A Southwest style, Tex-mex or Mexican style food typically comprises tomatoes, chiles, onions, jack cheese, shredded beef or chicken, cilantro and other common flavorings. A Greek style food typically comprises feta cheese, cucumbers, onions, cream fillings, lamb and typical gyros-type foods. A Hawaiian style food typically comprises ham, pineapple, macadamia nuts, etc. The pizza slice is packaged in the The dough useful in making the pizza food of the invention is typical light dough capable of commercial mixing, blending, sheeting and processing required to form the enclosed pizza slice. One preferred embodiment of the pizza dough of the invention is a light croissant-type dough providing a rich, flaky, light character that can survive manufacture, baking, packaging, freezing and preparation at home resulting in an attractive appetizing pizza slice. Other doughs can be selected according to the requirements of the pizza style selected by the manufacturer. Conventional pizza doughs and croissant doughs are well known and can be adapted for ease of manufacture.

After the roughly triangular pizza slice portion of the invention has been prepared, a cheese/herbal topping can be applied to the slice produce before baking or after baking. The formulation should be adapted to ease of application to the slice portion in a format such that the cheese and herbs are retained on the slice after manufacture and are present on the product after reheating by the ultimate consumer. Such toppings typically comprise a blend of a cheese and at least one herbal component combined with condiments such as salt, thickeners, extenders and binding agents. A conventional cheese or dried cheese food can be selected appropriate for the product style. Similarly, an herb or herbal blend can be selected in combination with the appropriate cheese for the product style selected.

The pizza food of the invention is manufactured in a process wherein the dough selected for the pizza style of the invention. A variety of dough process, formulation or recipes can be used. The following is preferred. The ingredients are typically added to the mixer at appropriate amounts and intervals and mixers are typically operated until the dough is well developed but not overworked. Dough is typically maintained at a temperature convenient for mixing and for sheeting. Once the dough is developed and at the right temperature, the dough is added to a sheeting line in portions appropriate for the equipment selected. The dough is processed and then laminated by adding an appropriate laminating fat to the sheeted dough at an amount of about 5 to about 25 wt % based on the dough using conventional fat addition equipment. Typically, a conventional baker's margarine is used. The sheeting equipment is operated to reduce the thickness of the dough sheet and to produce a laminated dough sheet having 9 to 100 layers of the dough, preferably 7 to 40 layers of the dough, typically 8 to 40 layers of dough. Once fully laminated, the dough is reduced in thickness to obtain the appropriate weight per square inch to meet product tolerances as discussed below. One or more thickness reduction steps may be required to obtain a final dough weight. Once the dough is the appropriate thickness, the dough is then split, cut or processed into the base and sealing layer portions.

The base and sealing layers are combined in the final product by adhering the perimeter of the triangular shaped base and sealing portions to form a seal on the perimeter of the pizza food. At this stage in the process, a light water mist is applied to the base dough sheet to ensure proper sealing of the sealing layer to the base layer. This mist is important to ensure that the final perimeter seal is mechanically stable and the filling will not leak from the finished product upon baking in the manufacturing facility, during reheating by the consumer and during consumption by the end user. The filling is deposited on the base dough sheet, a filling depositing applicator is used to place the filling on the dough base layer. The sealing layer is then placed over the bottom dough sheet and the filling and the moistened edges. Power driven equipment is then used to seal the portion of the food that will result in the base of the triangular shaped food. Also, the edges of the substantially isosceles triangular portion are also sealed at this time. Power driven pressing rollers or guillotine pressing stamp equipment can apply sufficient pressure with sufficient numbers of pressing steps to ensure that the sealing layer is adhered to the moistened base layer sufficiently to ensure the layer is mechanically stable during subsequent baking and consumer reheating.

The process discussed above can be used to prepare single portions of the pizza food or can be used to prepare a long sheet of dough and filling that can be subsequently sealed and cut into individual serving size portions. However, the overall process is identical having one major difference that the dough portions are cut prior to assembly for the individual single portions and in the continuous manufacture of sheeted laminated material, the individual portions are then cut after sealing.

The individual portions are then baked at a sufficient temperature for a sufficient period of time to fully cook the filling and to bake the exterior dough into a fully cooked crust. Once fully cooked, the product can then be enhanced with a variety of ingredients including products that can enhance the attractiveness of the baked material and increase the adherence of the cheese/herb topping. The product is then quick frozen at a temperature substantially below the freezing point of water for sufficient time to ensure that the interior of the filling is frozen before wrapping. The product is then combined with an appropriate shaped susceptor device and the pizza portion and susceptor are then shrink-wrapped with packaging designed to maintain the overall shape of the product and to protect the triangular apexes from breaking or other damage.

The enclosed pizza slice of the invention can be manufactured by first sheeting a laminated dough layer to a thickness of less than about 3 millimeters. Onto that sheet is placed in accurate registration, triangular areas of filling in a regular pattern (see FIG. 8). Onto the dough sheet containing the carefully placed filling portions is placed a second sheet of dough coextensive with the first. Prior to the addition of the second dough sheet, the first dough sheet is moistened with water to promote dough adhesion. The areas between the fillings are compressed such that the areas of dough containing no filling are pressed together to form the seal surrounding the filling. The seal can be maintained by a variety of compression techniques, however, a preferred technique involves use of a die adapted to the shape of the repeating pattern of filling add-on that compresses the zones between the filling portions to form a pattern of the individual serving size portions in the compressed dough sheet. The compression step can be conducted one or more times to ensure that the dough layers are satisfactorily compressed to obtain a reliable joint. Once the compression step(s) are complete, the individual serving size portions are separated using a cutting step. Any cutting implement can be used to divide the dough portions, however, the preferred cutting implement comprises a tool that presses the joint between the filling portions in compression as the implement passes through the dough layers. As such, the dough is not cut, but is simply separated by the pressure of the dividing implement. This separation technique improves the sealing aspect of the perimeter of the individual serving size pizza slice portions.

Once the individual serving size portions are divided, they are baked at the manufacturing facility for a period of time of about 3 to 10 minutes at 350° F. to 550° F. After completely cooking and leaving a pleasing golden brown appearance, the cooked individual serving size portions are then quickly frozen to an equilibrated temperature of about 0° F. and then are packaged in a susceptor envelope and then shrink-wrapped in conventional clear film enclosure with an appropriate label and cooking instructions. The susceptor envelope comprises an expandable envelope having a triangular shape and steam vents that can enclose substantially the entirety of the individual serving size portion of the pizza food of the invention.

When reheated, the individual film packaging is removed from the susceptor, the individual serving size pizza slice remains within the susceptor which is then introduced into a microwave oven and cooked for a sufficient period of time to reheat the pizza slice food using heat from the susceptor device. The individual serving size portion can also be reheated in a conventional, thermal or convection oven by exposing the slice to sufficient thermal energy to reheat the portion to consumption temperatures. A stable filling or sauce is used. Stability in the filling or sauce means that the filling or sauce does not change substantially in physical state or phase separation. The sauce retains its color, flavor and consistency.

The pizza slice of the invention includes a unique packaging system. The pizza slice, or two or more pizza slices of the invention, is associated with a triangular support layer. The triangular support layer typically extends dimensionally past the edges or sides and apexes of the triangular shaped pizza slice. The extended support layer protects the pizza slice from damage during manufacturing, packaging, distribution, sale and reheating processes. The pizza and support layer are packaged within a film envelope. Conventional, typically transparent, translucent or opaque film packaging can be used with adhered labels or labeling information printed directly onto the film package. Further, package inserts can be used as labeling information as well. Typical film packaging can include films made from commonly available polymeric materials including polyolefin such as polyethylene and polypropylene, polystyrene, polyester, polyvinylchloride and other commercially available film materials. Single or multilevel films can be used to obtain protection from the film and protection from the permeation of undesirable materials from the exterior to the interior of the package and to prevent moisture from leaving the package resulting in a dry undesirable product. Further, the packaging can prevent loss of flavor and other desirable flavor notes from the interior of the package. Such packaging can be closed using compression technology, adhesive technology or thermal technology for sealing the seams and edges of the formed packaging material.

The support structure for the pizza slice of the invention is preferably a cardboard/susceptor device. A triangular single layer susceptor can be used with the pizza slice of the invention. In use, the pizza and susceptor of the invention are removed from the film packaging, placed in a microwave oven wherein the microwave's contact with the susceptor layer of the support and provide heat to result in a cooked crispy desirable pizza slice. Alternatively, a more complex shaped susceptor envelope can be used. The envelope can be a triangular-shaped envelope that can enclose entirely one or more pizza slices of the invention. The triangular envelope typically comprises an interior shape that substantially conforms to the shape of one or more pizza slices of the invention and includes on one, two or all surfaces of the interior of the envelope susceptor material that can result in an even cooking of the pizza slice. As such, the susceptor envelope material is sized to be slightly larger than the pizza slice and conforms to dimensions that permits the pizza slice to be inserted into the support/susceptor envelope for cooking. In use, the susceptor support is folded into a support layer that can protect the pizza slice from damage. In use, the envelope is unfolded to obtain the interior volume, to insert the pizza slice into the volume wherein the pizza slice comes in contact with the susceptor surface of the envelope. The pizza slice is then cooked using conventional technology or preferably microwave technology to result in a fully cooked crispy pizza slice. One advantage of the envelope that contains substantially the entirety of the pizza slice is the convenience of handling the container after cooking. The container can act as a convenient container for the slice in that it can be transported from oven to table or can be conveyed conveniently at any consumption locus including away from the home at picnics, sporting events, school functions, military training exercises, or any other consumption locus where conventional knife and fork consumption of the food item is not convenient. The support susceptor container concept of the invention permits ease of consumption of the pizza food by hand, but protects the pizza food from contamination in the environment when the consume is not handling the food item. Further, the container permits the consumer to permit the pizza food to cool to comfortable consumption temperatures without undesirable contact between consumer and the hot item.

The preferable pizza support/susceptor/container is in the form of a triangular shape having accordion folds along the equal sides of the isosceles triangular-shaped container. The container can also comprise one or more vents to permit escape of cooking vapor and can comprise other openings throughout the container to permit viewing during cooking and consumption. The unique envelope support/susceptor/container device of the invention is typically cut from cardboard material containing a susceptor layer and then is folded into a useful shape prior to the final packaging of the manufactured unit. Typically, the food item is packaged by obtaining an uncooked or raw pizza slice or a fully cooked and crisp slice which is then placed on the susceptor. The combined susceptor pizza slice is then inserted into a film package that can contain a label insert. Alternatively, the packaging film can be preprinted with labeling information or prelabeled with an adhesively applied label.

### DETAILED DESCRIPTION OF THE DRAWINGS

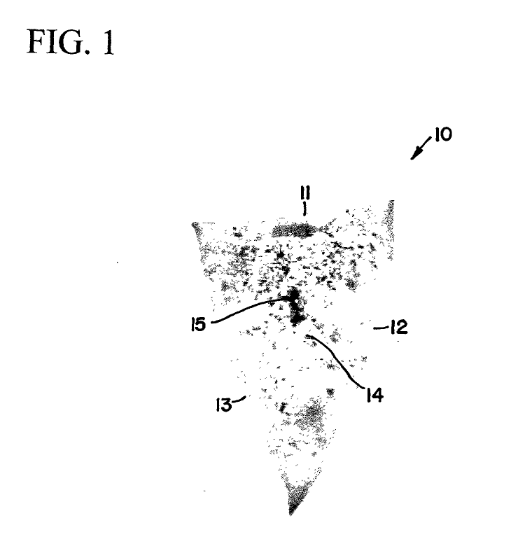

FIG. 1 is a photographic representation of the top of the pizza slice 10 of the invention. FIG. 1 is apparent to the roughly isosceles triangular shape of the pizza slice of the invention. In FIG. 1 and the toppings 14 combining cheese and herbal ingredients is shown. The base 11 of the slice, the sides 12 and 13 of the slice are also shown. The pizza slice shown is a fully cooked or baked product that has been reheated in the microwave oven before consumption. Vent 15 is shown centered on the top surface of pizza 10.

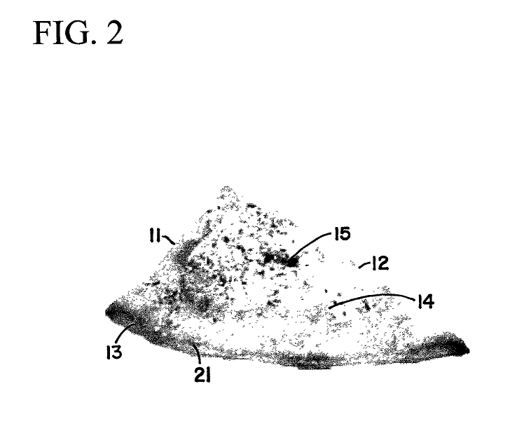

FIG. 2 is a photographic representation of the side of the pizza slice 10 of the invention. FIG. 2 makes apparent the roughly triangular shape of the pizza slice of the invention. Apparent in a photographic representation is the joint line 21 joining a top or sealing layer with the bottom or base portion layer. Also apparent in a photographic representation is the topping 14 on the top of the pizza slice of the invention and the impression 15 producing the crust edge. The base 11 of the slice, the sides 12 and 13 of the slice are also shown.

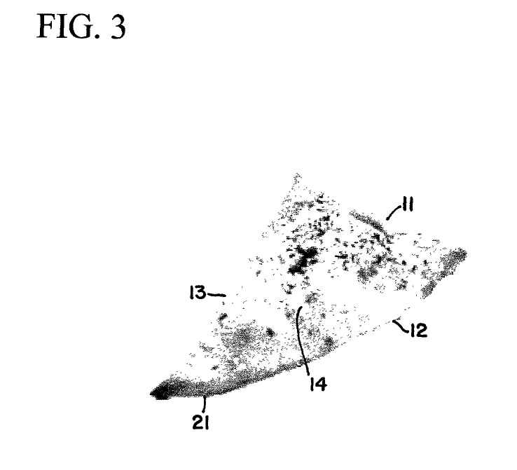

FIG. 3 is a photographic representation of the opposite side of the pizza slice 10 (opposite from the side shown in FIG. 2). FIG. 3 also shows the joint line 21 joining a top or sealing layer with the bottom or base portion layer of the pizza food. FIG. 3 also shows end 11 and sides 12 and 13 of the pizza slice food.

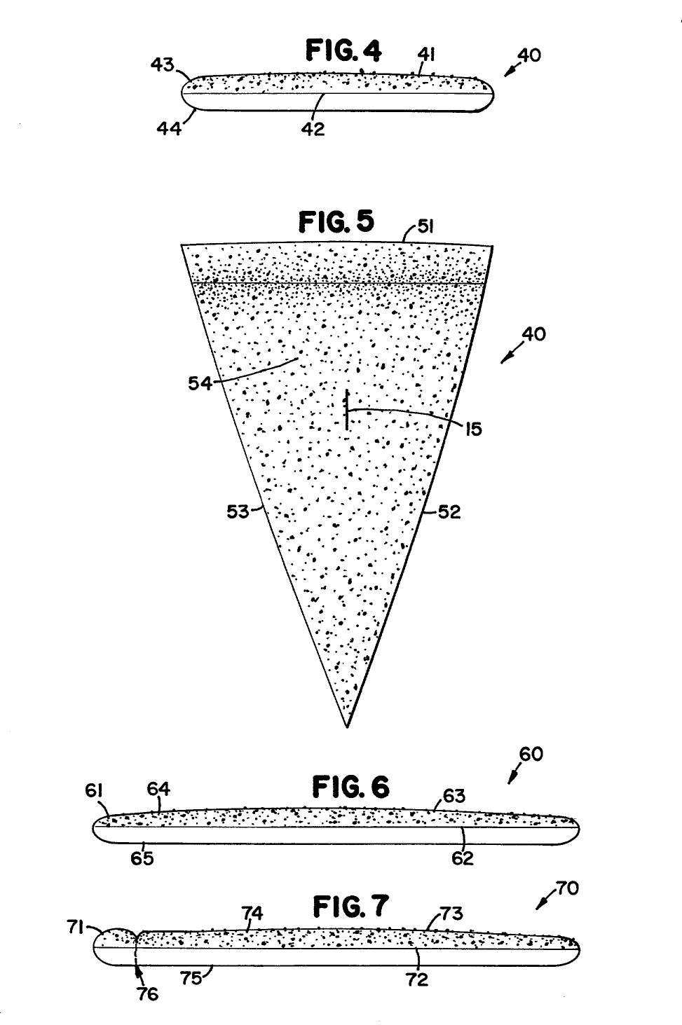

FIG. 4 is a graphical representation of the end of the pizza slice of the invention 40. The bottom or base portion layer 44 a shown in conjunction with a top or sealing portions 43 joined at a sealing line 42 to form the pizza food enclosing the pizza filling completely. The cheese and herbal topping 41 is shown evenly distributed on the top or sealing portion 43 of the pizza food.

FIG. 5 is a graphical representation of a top view of the pizza food 40 of the invention. FIG. 5 shows end 51, crust edge 55 and sides 52 and 53. To the cheese and herbal topping and 54 a shown evenly distributed on the top portion of the pizza food 40.

FIG. 6 is a graphical representation of a side view of the pizza food 60 of the invention. In the FIG. 6 the cheese and herbal topping and 63 is shown evenly distributed on the top or sealing portion 64 of the pizza slice of the invention. The top or sealing portion 64 of the invention is shown in joined into the bottom or base portion 65. The sealing portion 64 is joined to the base portion 65 at a joint line 62. The end portion 61 of the slice 60 of the invention comprises a simple compression joint between the top or sealing portion 64 handed the bottom or base portion 65.

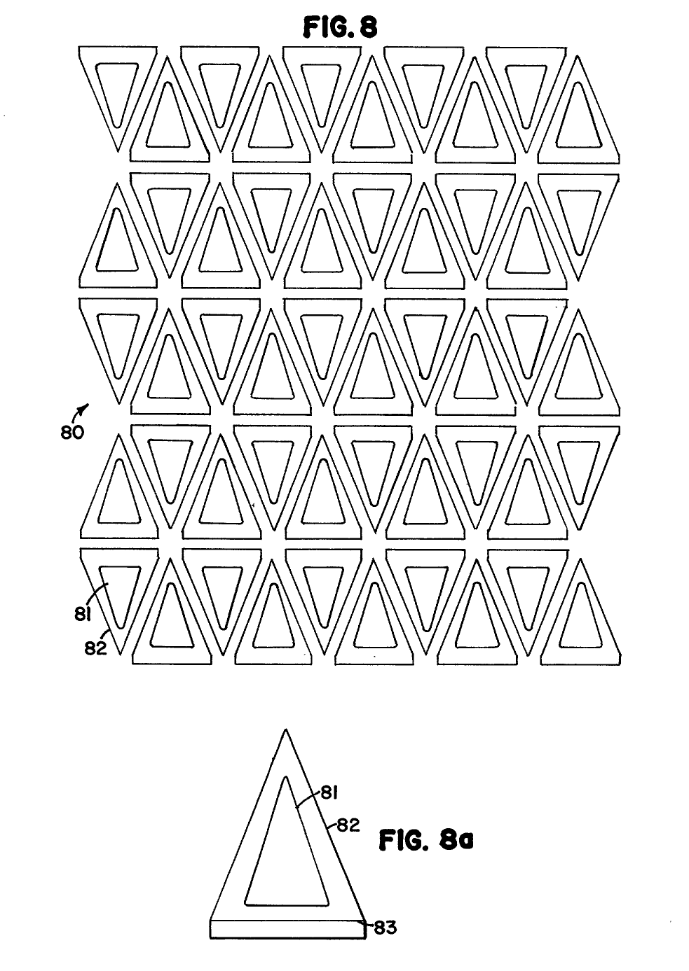

FIG. 7 is a graphical representation of a second embodiment of a side view of the pizza food 70 of the invention. FIG. 7 shows a second embodiment of the end portion 71 of the invention including a crust edge. The end portion 71 comprises a rounded perimeter that can comprise either dough or crust. Alternatively, the end portion 71 can comprise an enrobed cheese portion or cheese rope. Formed crust edge 76 is shown that can contain a cheese rope (not shown).

FIGS. 8 and 8a illustrate both a method of making a the pizza food of the invention and a representative pattern of the imprint of a tool used in compressing and cutting a pattern of the individual serving size portions of the pizza food of the invention. FIG. 8 shows the profile of the cut base or bottom dough portion 82 handed the filling portion 81 of the pizza food of the invention during assembly. FIG. 8 shows a pattern of the individual serving size portions of the pizza food of the invention that can be cut from a. sheeted dough layer during manufacture of the pizza food. The pattern 80 employs a compression feature 83 used to form the crust edge in the pizza. In the processing leading to the assembly of the pizza food the invention, the dough of the invention can be sheeted and laminated. The filling is registered and precisely placed onto the sheeted dough. Once the filling is precisely placed on the bottom dough layer, the upper or sealing layer of the dough is placed over the filling portions. Using the pattern as a guide, the individual serving size portions are first compression sealed and compression cut.

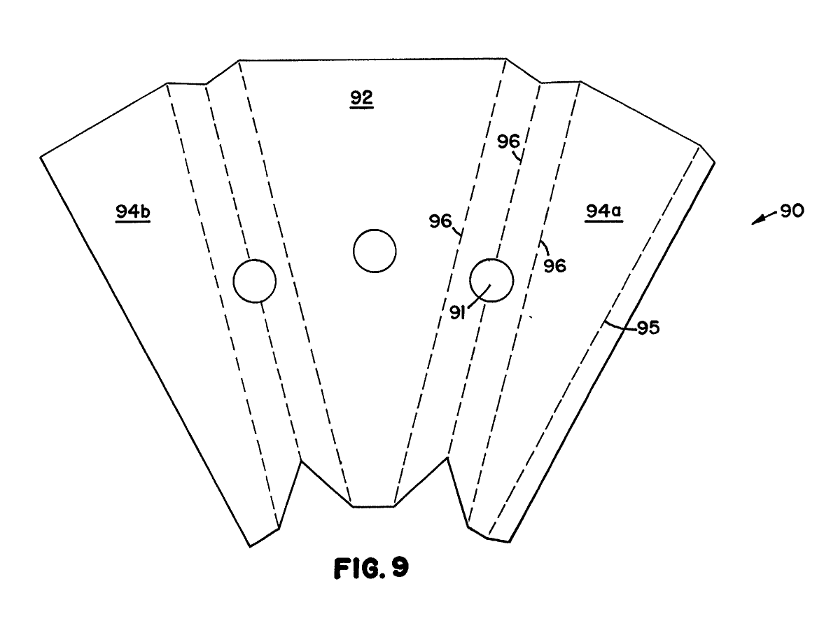

FIG. 9 is a drawing of the unfolded susceptor 90 that after forming and assembly is used as a packaging material and is a great device for the microwave reheating of the pizza slice of the invention. The unfolded susceptor 90 features a vent 91 that permits escape of steam during cooking. The base portion 92 is connected to top portions 94a and 94b to fold lines 96. In the assembly of this susceptor 90, a blank is cut from preformed material. The blank is then folded into an appropriate shape. The top portion of the center unit is assembled by adhering to portion 94a to 94b along line 95.

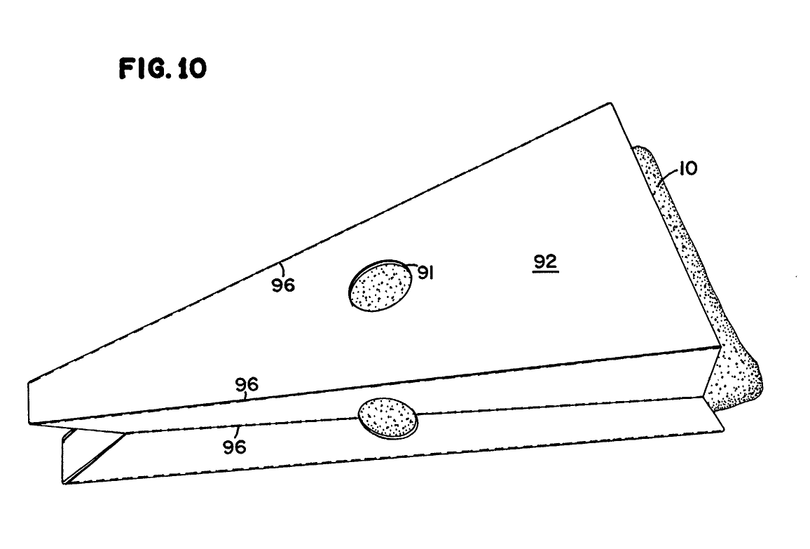

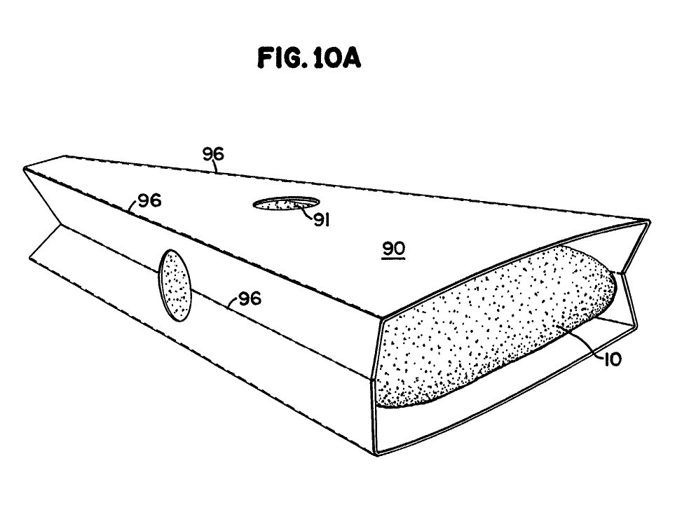

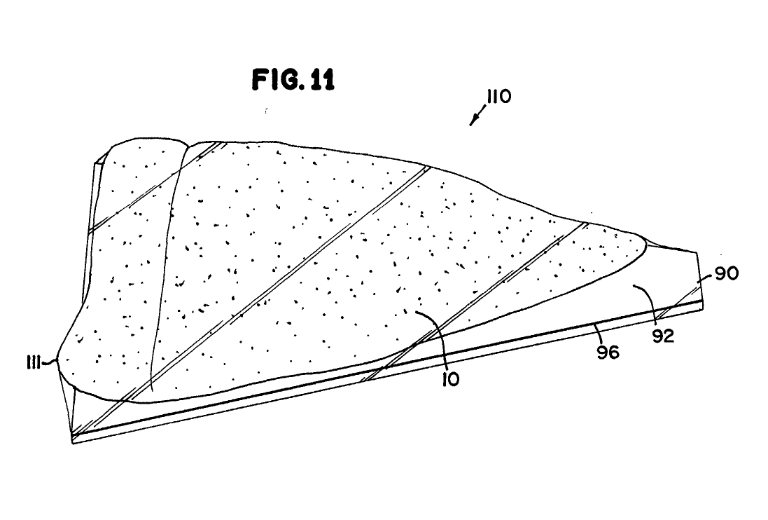

FIGS. 10 and 10a is a photographic representation of the susceptor of FIG. 9 in an assembled form containing one individual serving size portion of the pizza food 10 of the invention. An individual serving size pizza portion 10 of the invention is shown held within the susceptor device 90 after the device of FIG. 9 is folded into the appropriate container shape. The susceptor/container is vented through vent 91 and is folded along fold lines 96.

FIG. 11 is a photographic representation of the packaged pizza food of the invention with film 110 and container/susceptor 90. The surface 92 of the susceptor/container of the invention is shown with fold lines 96 and supporting pizza slice 10. The shrink wrap film 111 surrounds both pizza 10 and susceptor 90.

The susceptor device provides a number useful functions. First susceptor of the device acts as a part of the packaging system. The dimensions of the perimeter of the susceptor device is larger than the dimensions of the perimeter of the pizza slice of the invention. The larger susceptor device protects the pizza food of the invention can damage during packaging, storage and reuse. During reheating of the pizza food of the invention, acts as a heat source during microwave cooking. In conventional thermal or convection invention cooking, the susceptor device is not necessary. After reheating is completed, using either microwave or thermal cooking, the susceptor device can be used as a handy container for the cooked food. During consumption of the pizza food slice of the invention can be removed from the susceptor device and portions can be removed. The pizza can be returned to the susceptor device, acting as a convenient container, a during the time the consumer retains unused portion. The susceptor device is shaped and adapted to placement in coupler attachments often used in larger arenas, stadium or other venues in which pizza consumption is common.

### DESCRIPTION OF A PREFERRED EMBODIMENT

Process Outline

Mixing equipment such as a Peerless horizontal or SanCassiano spiral style mixer will be used for the dough production. All of the ingredients are added to the mixer and mixed to development. The mix time for a horizontal style mixer is approx. 20 minutes. The spiral mixer mix time is 2 minutes in low speed and 7 minutes in high speed. The desired dough temperature after mixing is between 68° and 72° F.

Processing equipment such as a Fritsch Laminator 3000 sheeting line can be used to process the dough sheet and make-up the product into its final pre-baked dimensions. The laminator 3000 is a reduced stress sheeting line with a three-legged configuration for laminated bakery products. The dough is transferred from the mixing stage to a Fritsch Preportioner that divides the dough into approximately 40 lb. dough pieces. The preportioner feeds the dough extruder that forms the dough into a thick sheet. The given mass and width of the extrusion is based off the line rate that is desired in the operation of the production line. The margarine enrobed dough sheet is extruded onto the thick dough sheet at the rate of 9 to 11% based on the dough weight using a Fritsch Fat Pump. The dough sheet sandwiches or enrobes the margarine in the middle of the dough to seal in the margarine. This enables the lamination steps to be accomplished with out the margarine being lost in the processing. The margarine enrobed dough sheet is then reduced in thickness with a Satellite reduction unit. This is a multiple roller unit that reduces the thickness of the dough sheet with a low amount of stress. The dough sheet can be laminated to 4 layers. Laminating means to fold the dough over itself to make a given number of layers of dough/fat sheet. The dough sheet makes a 90° direction change to accomplish the laminations. This will complete the “first leg” of the laminating line. The laminated dough sheet is again reduced in thickness with a Satellite reduction unit. The dough sheet is then laminated to 4 layers. Laminating means to fold the dough over itself to make a given number of layers of dough/fat sheet. The dough sheet makes a 90′-direction change to accomplish the laminations. This will complete the “second leg” of the laminating line. The dough sheet can consist of, for example, 20 to 28 layers or 24 to 26 layers or other convenience degree of lamination. A range of 9 to 36 layers in the dough will be used to adjust the layering effect to the final product quality that is desired by the customer.

The laminated dough is then reduced in thickness to obtain the proper dough weights to meet product tolerances for production. Several sheeting reduction stations are used to accomplish this process. The number of sheeting stations is dependent upon the final line rates that are desired. This section of the line is considered to be the “third leg” of the sheeting line. The final dough sheet is split to the “Top or sealing layer and the Bottom or base” portions of the product. The following steps are all synchronized in the PC control unit of the sheeting line to insure proper timing and product quality. The following is the make-up procedure for the bottom dough sheet:

A light water mist needs to be applied across the bottom dough sheet to insure proper sealing of the top and bottom dough sheets. This is a critical step to insure that the dough layers are sealed and the filling will not “leak” out of the finished product upon baking in the manufacturing facility or at the consumer. The fillings are specially formulated to be stable to help prevent leakage, however the seal is still a critical factor. An additional water drip in the crust lip area will be necessary to help the lift so the crust edge is round or more prevalent.

The filling depositor will place the pattern of filling pieces on the bottom dough sheet. A piece of equipment such as a Nutec filling depositor can be used to place the pattern of filling pieces on the bottom dough sheet. The Nutec depositor has the ability to precisely form and place the filling piece of the product assembly. This is a critical step to insure the product seal and elegance of the finished product. The top dough sheet will be slightly over-fed on top of the bottom dough sheet. This will help the dough flow between the filling pieces to aid in the sealing and make-up of the product. The top dough sheet is lifted onto a cross over conveyor that will place the dough sheet directly over the “bottom sheet of dough. The top dough sheet will also have vent holes cut into the sheet in registered pattern. The vent holes serve as a pressure relief mechanism in the make up process to help insure a proper seal. The vent is an escape point to vent off excess moisture in the product in the baking process. The vent also adds an elegance or decoration value to the vent of the finished product Power driven 5 mm. pressing rollers will make a lateral impression to simulate the crust lip. A guillotine-pressing stamp will incorporate a double pressing system and a third cutting section that stamps the outline of the product in to the final shape. The two stage pressing section, double stamps the top and bottom dough sheets with a high hydraulic or pneumatic pressure to seal the sheets together. The cutting section of the stamps or cuts on the pressed area to insure a seal of the dough sheets this is also one of the tricks of the trade to better seal two sheets of dough together. These three stages along with the uniform water mist application accomplish the seal of the edges of the product.

Vertical and lateral separation of the product will be needed prior to entering the oven to insure proper bake. An oven such as the Danish Food Equipment (OFE) can be selected from the range of useful ovens. A preferred oven belt style is a belt made of a herringbone design to allow for better heat transfer for a uniform bake. The bake time is approximately 3-10 minutes at 350° F. to 500° F. oven temperature. Air velocity, humidity, top bottom heat ratio, and temperature are some of the control factors to adjust the baking profiles.

The product is sprayed with a topical solution such as bake sheen, in a uniform pattern of coverage. The bake sheen aids in the shine of the product and as an adhesive to hold the cheese and herb toppings on the product through the remainder of the process. The product is topped with grated dried cheeses and herb blends. The product is frozen using a Northfield blast freezer with a setting of approximately −20° F. to −80° F. with a freezing time of 30 to 80 minutes. The product is completely frozen at this point.

The product is placed on top a specially designed microwave susceptor. The product and susceptor or shrink-wrapped to protect the tips and crust lip of the product as well as keeping the toppings in place during packaging and shipping. The susceptor design is a pleated triangular shaped design. The periphery of the susceptor is slightly great in size than the product to help protect the tips and crust lip of the product. The susceptor has vent holes strategically placed to help vent and to bake the product in the microwave. At this time the product will be packed 1-10 or 2-4 to a sell unit, however other bulk pack combinations may be used in the fixture.

PREFERRED DOUGH RECIPE

| | Amount |
|---|---|
| Ingredients | (Parts by Wt %) |
| Flour | 45-60 |
| Water | 25-35 |
| Margarine, oil, fat, shortening | 1-15 |
| Sugars | 1-5 |
| Non-Fat Dry Milk | 0-3 |
| Compressed Yeast | 1-3 |
| Dough Conditioner | 0.5-2 |
| Powdered Eggs | 0.0-3 |
| Salt | 0.5-1.5 |
| Baking Powder, Single-Acting | 0.0-1.0 |
| TOTAL | 100.00 |

PEPPERONI
FILLING SUBASSEMBLY

| Ingredient | Wt % |
|---|---|
| Cheese | 35-50 |
| Pizza Sauce | 20-35 |
| Pepperoni | 15-30 |
| Food Starch | 0.3-1.5 |

FINISHED PRODUCT

| | Formula Weight |
|---|---|
| Ingredient | (oz) |
| Dough | 0.75-4 |
| Pepperoni Filling | 0.74-4 |
| Dusting Flour | 0.05-0.3 |
| Bake Sheen Glaze | 0.05-0.25 |
| Italian Cheese Herb Blend | 0.03-0.2 |
| FORMULA WEIGHT | 2-7 |

CHIPOTLE SPICE BLEND SOUTHWEST STYLE CHICKEN
FILLING ASSEMBLY

| Ingredient | Wt % |
|---|---|
| Southwest Sauce | 25-40 |
| Chicken Pieces | 20-35 |
| Cheese | 10-30 |
| Pepper Red | 2-10 |
| Pepper Green | 2-10 |
| Onion | 2-10 |
| Corn | 2-10 |
| Pepper Roasted | 2-10 |
| Starch | 0.5-3 |
| Gums | 0-2 |

FINISHED PRODUCT

| | Formula Weight |
|---|---|
| Ingredient | (oz) |
| Dough | 0.75-4 |
| Southwest Style Chicken | 0.75-4 |
| Filling | |
| Dusting Flour | 0.05-0.3 |
| Bake Sheen Glaze | 0.05-0.25 |
| Parmesan Cheese and | 0.03-0.20 |
| Cilantro Topping | |
| Formula Weight | 2-7 |

FIVE ITALIAN CHEESE AND TOMATO
FILLING

| Ingredient | Percent |
|---|---|
| Cheese blend | 50-80 |
| Tomato | 10-30 |
| Sauce | 10-25 |
| Modified Food Starch | 0.5-3 |

FINISHED PRODUCT

| | Formula Weight |
|---|---|
| Ingredient | (oz) |
| Dough | 0.75-4 |
| Five Italian Cheese Filling | 0.75-4 |
| Dusting Flour | 0.05-0.3 |
| Bake Sheen Glaze | 0.10-0.03 |
| Cheese and Herb Topping | 0.3-0.2 |
| TOTAL | 2-7 |

ITALIAN CHEESE HERB BLEND
ITALIAN CHEESE HERB BLEND SUBASSEMBLY

| Ingredient | Percent |
|---|---|
| Parmesan/Romano Blend | 90-97 |
| Garlic Powder | 1-4 |
| Dehyd. Parsley Flakes | 1-4 |
| Oregano, Whole | 1-4 |
| TOTAL | 1000 |

The above discussion, recipes, process information handed disclosure provides a basis for understanding the meets and bounds of the invention and discloses a preferred embodiment. However, since many embodiments of the invention can be made without departing from the spirit and scope of the invention, the invention resides in the claims hereinafter appended.

We claim:

1. An individual sized serving portion of a food configured for manual handling and consumption, the food comprising, in a baked form:
(a) a base crust layer in the shape of a circular sector with an edge and sides of equal length, the edge and sides forming a first perimeter;
(b) a sealing crust layer having a shape that conforms to the perimeter of the base layer forming a second perimeter; and
(c) a pizza filling held therebetween, the base crust and the sealing crust forming a mechanically stable joint along the conforming first and second perimeters sealing the filling within a sealed food item;
wherein the filling is substantially stable at common cooking temperatures.

2. An individual sized serving portion of a pizza food configured for manual handling and consumption, the food comprising, in an unbaked form:
(a) a base dough layer in the shape of a circular sector with an edge and sides of equal length, the edge and sides forming a first perimeter;
(b) a sealing dough layer having a shape that conforms to the perimeter of the base layer forming a second perimeter; and
(c) a pizza filling held therebetween, the base layer and the sealing layer forming a mechanically stable joint along the conforming first and second perimeters sealing the filling within a sealed food item;
wherein the filling is substantially stable at common cooking temperatures.

3. The food of claim 1 wherein the edge is a curved edge.

4. The food of claim 1 wherein the filling comprises a tomato base filling comprising pizza condiments.

5. The food of claim 3 wherein the filling comprises a meat component.

6. The food of claim 2 wherein the dough layer is baked prior to shipment forming a crispy crust envelope that does not toughen during microwave reheating.

7. The food of claim 1 wherein the sealing crust layer contains a vent aperture having an area of less than about 1 square centimeter to vent steam generated during cooking.

8. The food of claim 1 wherein the food item comprises a topical coating.

9. The food of claim 1 wherein the food item contains a browning agent.

10. The food of claim 1 wherein the curved edge comprises a crust edge.

11. The food of claim 9 wherein the crust edge comprises an enclosed rope of cheese.

12. The food of claim 1 wherein the edge has a sector length of between 5 and 15 centimeters.

13. The food of claim 1 wherein the substantially equal sides of the crust have a length of about 5 to 25 centimeters.

14. The food of claim 1 wherein the filling has a filling weight in an uncooked state of about 20 to 120 grams.

15. The food of claim 2 wherein the base dough layer and the sealing dough layer has an uncooked weigh of about 10 to 60 grams and is substantially the same weight.

16. The food of claim 1 wherein the food comprises a condiment additive layer in the exterior of the sealing crust.

17. The food of claim 15 wherein the condiment layer comprises a combination of cheese and at least one herb.

18. The food of claim 16 wherein the herbs comprise an Italian herb seasoning.

19. The food of claim 1 wherein the food comprises an exterior coating of a topical application in an amount of about 1 to 10 grams.

20. The food of claim 2 wherein the food comprises an exterior coating of a topical application in an amount of about 1 to 8 grams.

21. The food of claim 1 wherein the sealing dough layer and the base dough layer have an uncooked thickness dimension of about 1 millimeter to 1.5 centimeters and are substantially equal in thickness.

22. The food of claim 2 wherein the filling layer forms a layer having a thickness of about 5 to 25 millimeters in a precooked form.

23. The food of claim 2 wherein the area of the sealing layer is about 20 to 200 in².

24. The food of claim 2 wherein the area of the sealing layer is about 25 to 150 in².

25. The food of claim 1 wherein the food is packaged in a container is an amount of about 2 to 100 slices per container.

26. A method of manufacturing an individual serving size portion pizza slice, method comprising:
(a) sheeting a dough portion to form a first sheet and laminating the first sheet to form a second sheet;
(b) forming a plurality of separate areas comprising a stable pizza filling on a second sheet to form a filled sheet;
(c) placing a second layer of laminated dough on the filled sheet to form a filled laminate;
(d) compressing dough portions of the filled laminate between the separate areas comprising a pizza filling forming a sheet of undivided portions; and
(e) dividing the sheet of undivided portions into separate serving size portions of a pizza food.

27. The method of claim 26 wherein the first sheet is moistened before placing of the second layer.

28. The method of claim 26 wherein the separate serving size portions of pizza food are baked a temperature of about 350° F. to 550° F. degrees Fahrenheit.

29. The method of claim 26 wherein the separate areas comprising a pizza filling are substantially formed in the shape of an equilateral triangle.

30. The method of claim 29 wherein the dough portions of the filled laminate between the separate areas comprising a pizza filling forming a sheet of undivided portions are compressed while they are divided.

31. An individually packaged sized serving portion of a pizza food configured for manual handling and consumption, the food comprising a film enclosure containing a susceptor envelope and a pizza food; the pizza food comprising, in a baked form:
(a) a base crust substantially in the shape of an isosceles triangle having sides of substantially equal length and edge, the edge and sides forming a first perimeter having a surface area of less than about 30 in²;
(b) a sealing crust having a shape that conforms to perimeter of the base layer and has an area equal to or greater than the base crust; and
(c) about 20 to 120 grams of a pizza filling placed on the base crust in the shape of a complementary but smaller isosceles triangle, the filling sealed within the food;
the susceptor comprising an envelope conformed to include substantially all of the pizza food within the envelope, the susceptor capable of folding to form a protective insert in the individually packaged portion and capable of reaching temperatures greater than about 400 degrees Fahrenheit during microwave cooking; and the film enclosure comprising a shrink-wrapped polyolefin film.

32. The food of claim 31 wherein the surface area of the base crust is about 3 to 25 in².

33. The food of claim 31 wherein they sides of substantially equal length are about 5 to 30 cm.

34. The food of claim 31 wherein the length of the edge is about 5 to 15 cm.

35. The food of claim 31 wherein the susceptor comprise an envelope having at least one steam vent.

36. The food of claim 31 wherein the food is packaged in a container is an amount of about 2 to 20 slices per container.

37. An individually packaged single serving portion of a food configured for manual handling and consumption, the packaged food comprising,
(i) a baked food comprising:
(a) a base crust layer shapes as a circular sector with an edge and sides of equal length, the edge and sides forming a first perimeter;
(b) a sealing crust layer having a shape that conforms to the perimeter of the base layer forming a second perimeter; and
(c) a pizza filling held therebetween, the base crust and the sealing crust forming a mechanically stable joint along the conforming first and second perimeters sealing the filling within a sealed food item wherein the filling is substantially stable at common cooking temperatures
(ii). a container shaped susceptor adapted to the shape of the baked food; and
(iii) a film wrap surrounding the food and container.

38. The food of claim 37 wherein the sealing crust layer contains a vent aperture having an area of less than about 1 square centimeter to vent steam generated during cooking.

39. The food of claim 37 wherein the food item comprises a topical coating.

40. The food of claim 37 wherein the food item contains a browning agent.

41. The food of claim 37 wherein the curved edge comprises a crust edge.

42. The food of claim 41 wherein the crust edge comprises an enclosed rope of cheese.

43. The food of claim 37 wherein the edge has a sector length of between 5 and 15 centimeters.

44. The food of claim 37 wherein the substantially equal sides of the crust have a length of about 5 to 25 centimeters.

45. The food of claim 37 wherein the filling has a filling weight in an uncooked state of about 20 to 120 grams.

46. The food of claim 37 wherein the base dough layer and the sealing dough layer has an uncooked weigh of about 10 to 60 grams and is substantially the same weight.

48. The food of claim 37 wherein the food comprises a condiment additive layer in the exterior of the sealing crust.

49. The food of claim 37 wherein the condiment layer comprises a combination of cheese and at least one herb.

50. The food of claim 49 wherein the herbs comprise an Italian herb seasoning.

51. The food of claim 37 wherein the food comprises an exterior coating of a topical application in an amount of about 1 to 10 grams.

52. The food of claim 37 wherein the food comprises an exterior coating of a topical application in an amount of about 1 to 8 grams.

53. The food of claim 37 wherein the sealing dough layer and the base dough layer have an uncooked thickness dimension of about 1 millimeter to 1.5 centimeters and are substantially equal in thickness.

54. The food of claim 37 wherein the filling layer forms a layer having a thickness of about 5 to 25 millimeters in a precooked form.

55. The food of claim 37 wherein the area of the sealing layer is about 20 to 200 in².

56. The food of claim 37 wherein the area of the sealing layer is about 25 to 150 in².
